(19) United States
(12) Patent Application Publication
(10) Pub. No.: US 2011/0059383 A1
(43) Pub. Date: Mar. 10, 2011

(54) COMBINED CELL STRUCTURE FOR SOLID OXIDE FUEL CELL

(76) Inventor: Shunsuke Taniguchi, Suwon-si (KR)

(21) Appl. No.: 12/721,381

(22) Filed: Mar. 10, 2010

Related U.S. Application Data
(60) Provisional application No. 61/240,095, filed on Sep. 4, 2009.

(51) Int. Cl. H01M 8/24

(52) U.S. Cl. 429/465

(57) ABSTRACT

A combined cell structure for a solid oxide fuel cell includes a plurality of tube-type or flat-tube-type solid oxide fuel cells combined in series in a longitudinal direction. The combined cell structure includes first and second cells each having a first electrode, a second electrode and an electrolyte layer between the first and second electrodes. The combined cell structure further includes a support member connecting the cells. The support member can include a first sub-support member passing through a hollow portion of the first cell, and a second sub-support member passing through a hollow portion of the second cell. In the combined cell structure, one end of the first sub-support member is fixedly coupled to one end of the second sub-support member. Accordingly, the first and second cells are connected to each other in the direction of reactant flow.

### CROSS-REFERENCE TO RELATED APPLICATION

This application claims priority to and the benefit of Provisional Patent Application No. 61/240,095 filed in the U.S. Patent and Trademark Office on Sep. 4, 2009, the entire contents of which are incorporated herein by reference.

### BACKGROUND OF THE INVENTION

1. Field of the Invention

Embodiments of the present invention relate to combined cell structures for solid oxide fuel cells.

2. Description of Related Art

Solid oxide fuel cells (SOFCs) have the advantages of no pollution, high-efficiency power generation, and the like. SOFCs are used in stationary power generation systems, small power supplies and vehicle power sources. An SOFC cell may be manufactured as a tube-type cell, a flat-tube-type cell or a flat-plate-type cell. The tube-type or flat-tube-type cells may be cathode supported cells, segmented in series cells, anode supported cells, or the like.

Currently, anode supported SOFC cells are frequently used for small SOFC systems in the range of 1 to 10 KW. On the other hand, cathode supported SOFC cells or segmented in series cells are frequently used for large SOFC systems in the range of 100 KW or more.

### SUMMARY OF THE INVENTION

In embodiments of the present invention, a combined cell structure for a solid oxide fuel cell (“SOFC combined cell structure”) is used to easily manufacture a large SOFC system using a plurality of anode supported SOFC cells.

In other embodiments, an SOFC combined cell structure is durable against thermal and mechanical stresses (which are typically generated with a plurality of anode supported SOFC cells that are combined in series), enables simplification of manifold design, and prevents increases in current collecting resistance.

According to embodiments of the present invention, a combined cell structure for a solid oxide fuel cell includes first and second cells each cell having a first electrode, a second electrode and an electrolyte layer between the first and second electrodes. The combined cell structure further includes a support member for connecting the first and second cells. The support member may include a first sub-support member passing through a hollow portion of the first cell, and a second sub-support member passing through a hollow portion of the second cell. One end of the first sub-support member is fixedly coupled to one end of the second sub-support member.

In one embodiment, the support member includes a solid rod passing though the unit cells. When the support member includes sub-support members, each of the first and second sub-support members may include a solid rod.

In one embodiment, the support member includes a hollow tube passing through the unit cells. When the support member includes sub-support members, each of the first and second sub-support members may include a hollow tube. The hollow tube may have a plurality of openings or holes between both ends.

The first and second support members may be formed of stainless steel, nickel or a nickel alloy.

One end of the first sub-support member may include a first coupling, and one end of the second support member may include a second coupling. The first and second couplings may be directly coupled to each other. Alternatively, the combined cell structure may include an adapter for connecting an end of the first sub-support member to an end of the second sub-support member.

The combined cell structure may include a porous member between the first electrodes of the unit cells and the support member. The porous member may include metal felt, metal mesh or a combination thereof.

The combined cell structure may include a connector for connecting the first and second unit cells. The connector may contact the first or second sub-support member. The connector may be configured to resiliently deform in response to stress from the first and/or second cells. The connector may be connected to at least one of the first and second unit cells.

The combined cell structure may further include a sealing member between at least one unit cell and the connector. For example, the sealing member may be between the first unit cell and the connector and/or between the second cell and the connector.

The combined cell structure may include a current collector in contact with the second electrode.

The first electrode may take any shape, for example, a circular shape, an elliptical shape or a polygonal tube shape. The first electrode may be an anode, and the second electrode may be a cathode.

The ends of the unit cells that are not connected to each other (unconnected ends) may be opened. In some embodiments, one of the unconnected ends of a cell stack may be opened, and the other of the unconnected ends may be closed.

The combined cell structure may further include at least one third cell between the first and second cells and connected to the first and second cells in series in the longitudinal direction.

According to other embodiments of the present invention, a combined cell structure for a solid oxide fuel cell includes a first sub-cell and a second sub-cell. The first sub-cell includes a first cell having a first electrode for forming a tubular support, a second electrode on the first electrode, and an electrolyte layer between the first and second electrodes. A rod-shaped first sub-support member passes through an interior of the first electrode in a longitudinal direction. The second sub-cell includes a second cell having a first electrode for forming a tubular support, a second electrode on the first electrode and an electrolyte layer between the first and second electrodes. A rod-shaped second sub-support member passes through an interior of the first electrode in a longitudinal direction. One end of the first sub-support member is fixedly connected to an end of the second sub-support member such that the first and second cells are connected in series in a longitudinal direction.

### BRIEF DESCRIPTION OF THE DRAWINGS

FIG. 1A is a schematic front view of an SOFC combined cell structure according to an embodiment of the present invention.

FIG. 1B is a cross-sectional view of a tube-type SOFC unit cell according to an embodiment of the present invention.

FIG. 1C is a cross-sectional view of a flat-tube-type SOFC unit cell according to another embodiment of the present invention.

FIG. 2 is an enlarged, partial cross-sectional view of a combined cell structure according to an embodiment of the present invention.

FIG. 3A is a cross-sectional view of the sub-support member depicted in FIG. 2.

FIG. 3B is a cross-sectional view of the connector depicted in FIG. 2.

FIG. 3C is a front view of the connector depicted in FIGS. 2 and 3B.

FIG. 4 is a cross-sectional view of an SOFC stack including the combined cell structure of FIG. 2.

FIG. 5 is a cross-sectional view of an SOFC stack including a combined cell structure including a sub-support member according to another embodiment of the present invention.

FIG. 6 is a cross-sectional view of the sub-support member depicted in the combined cell structure of FIG. 5.

FIG. 7 is a partial cross-sectional view of a combined cell structure including a sub-support member according to another embodiment of the present invention.

FIG. 8 is a cross-sectional view of the sub-support member depicted in the combined cell structure of FIG. 7.

FIGS. 9A to 9C are cross-sectional diagrams illustrating a process of manufacturing an SOFC stack having the combined cell structure of FIG. 7.

FIG. 10 is a cross-sectional view of an SOFC stack including a combined cell structure including a sub-support member according to still another embodiment of the present invention.

FIG. 11 is a cross-sectional view of the sub-support member depicted in the combined cell structure of FIG. 10.

FIG. 12 is a partial cross-sectional view of a combined cell structure including a sub-support member according to yet another embodiment.

FIG. 13 is a cross-sectional view of the sub-support member depicted in the combined cell structure of FIG. 12.

FIGS. 14A to 14C are cross-sectional diagrams illustrating a process of manufacturing an SOFC stack having the combined cell structure of FIG. 12.

FIG. 15 is a cross-sectional view of an SOFC stack having a combined cell structure including a sub-support member according to still yet another embodiment of the present invention.

FIG. 16 is a cross-sectional view of the sub-support member depicted in the combined cell structure of FIG. 15.

FIG. 17A is a cross-sectional diagram illustrating the connection of two sub-support members to an adapter according to an embodiment of the present invention.

FIG. 17B is a cross-sectional diagram illustrating the connection of two sub-support members to an adapter according to another embodiment of the present invention.

FIG. 18 is a cross-sectional view of the connection of two sub-support members according to yet another embodiment of the present invention.

### DETAILED DESCRIPTION OF THE INVENTION

Hereinafter, exemplary embodiments of the present invention will be described with reference to the accompanying drawings. In the following description, detailed discussion of known functions and structures may be omitted. In the drawings, like elements are represented by like reference numerals, and the dimensions of components may be exaggerated for clarity.

The term “manifold,” as used herein, refers to a structure having a flow path for the smooth supply, distribution or discharge of a fluid. With respect to the drawings and their related descriptions in this specification, a housing or boundary wall forming a manifold is designated by a reference numeral and referred to as the manifold, for convenience of illustration.

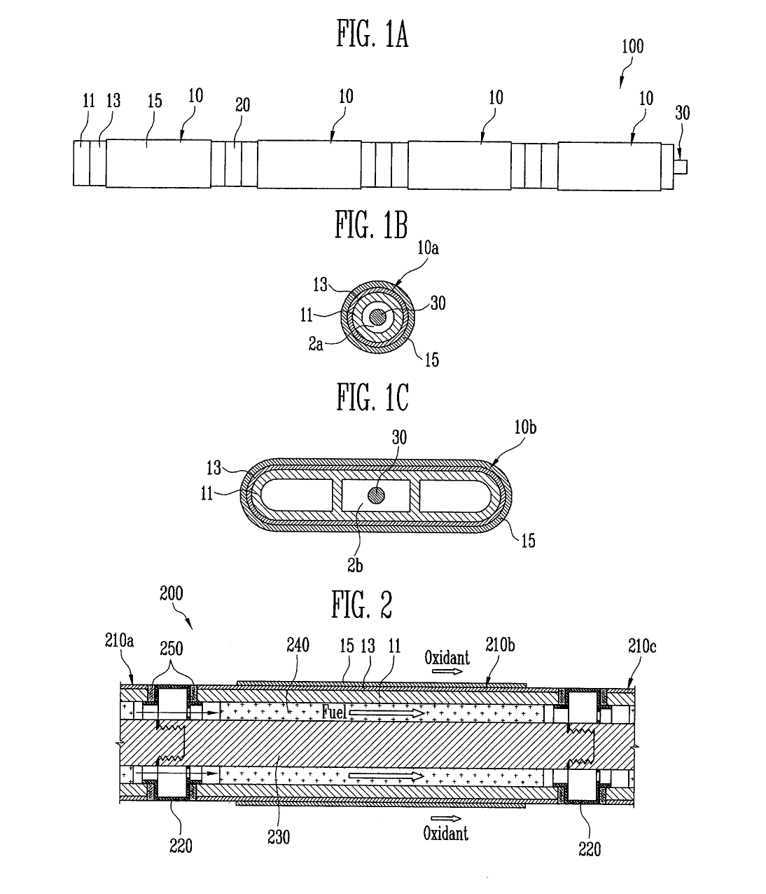

FIG. 1A is a schematic front view of an SOFC combined cell structure according to an embodiment of the present invention. FIGS. 1B and 1C are cross-sectional views of SOFC unit cells, which may be used in the combined cell structure of FIG. 1A. Referring to FIG. 1A, the combined cell structure 100 includes a plurality of tube-type or flat-tube-type SOFC cells 10 connected to each other along a longitudinal direction of the combined cell structure 100. A solid support member 30 passes through the combined SOFC cells 10 from one end of the combined structure 100 to the other end of the combined structure 100. The plurality of SOFC cells 10 are connected in series and are mechanically and/or physically stabilized by the support member 30. As used herein, “connected in series” refers to a structure in which the tube-type or flat-tube-type SOFC cells (each having a length) are connected to each other along the longitudinal direction. A connector 20 may be disposed between adjacent SOFC cells.

In one embodiment, the support member 30 may pass through the hollow portions of the respective SOFC cells 10. Alternatively, the support member 30 may be divided into a plurality of sub-support members, where each SOFC cell includes a sub-support member, and the sub-support members are connected to each other along the longitudinal direction to thereby connect the adjacent SOFC cells. Each of the SOFC cells provided with a sub-support member may be referred to as an SOFC sub-cell. The SOFC sub-cells become unit cell structures making up the combined cell structure.

Each of the SOFC cells 10 includes a first electrode 11, a second electrode 15 and an electrolyte 13 between the first and second electrodes 11 and 15. The first electrode 11 is an anode or cathode. When the first electrode 11 is an anode, the second electrode 15 is a cathode. When the first electrode 11 is a cathode, the second electrode 15 is an anode. The electrolyte 13 is an ion conductive oxide material for transporting oxygen ions or protons. The SOFC cell 10 becomes a unit in which electricity and water are produced by the electrochemical reaction of hydrogen and oxygen respectively supplied to the anode and cathode.

In one embodiment, a porous Ni/YSZ cermet may be used as the material of the first electrode 11. A porous mixed conducting oxide may be used as the material of the second electrode 15. Yttria stabilized zirconia (YSZ) may be used as the material of the electrolyte 13.

In one embodiment, the SOFC cells through which the support member 30 passes may be tube-type SOFC cells 10a having a generally circular cross-section, as illustrated in FIG. 1B, or flat-tube-type SOFC cells 10b having generally elliptical cross-sections, as illustrated in FIG. 1C. When the cells are tube-type SOFC cells 10a, the support member 30 may pass through a hollow portion 2a of each of the SOFC cells 10a, as depicted in FIG. 1B. When the cells are flat-tube-type SOFC cells 10b, the cells may include three hollow portions, and the support member 30 may pass through the central hollow portion 2b, as depicted in FIG. 10.

According to some embodiments, the combined cell structure includes a plurality of anode supported SOFC cells connected in series. However, the combined cell structure can also include a plurality of tube-type or flat-tube-type cathode supported SOFC cells, segmented in series cells or the like.

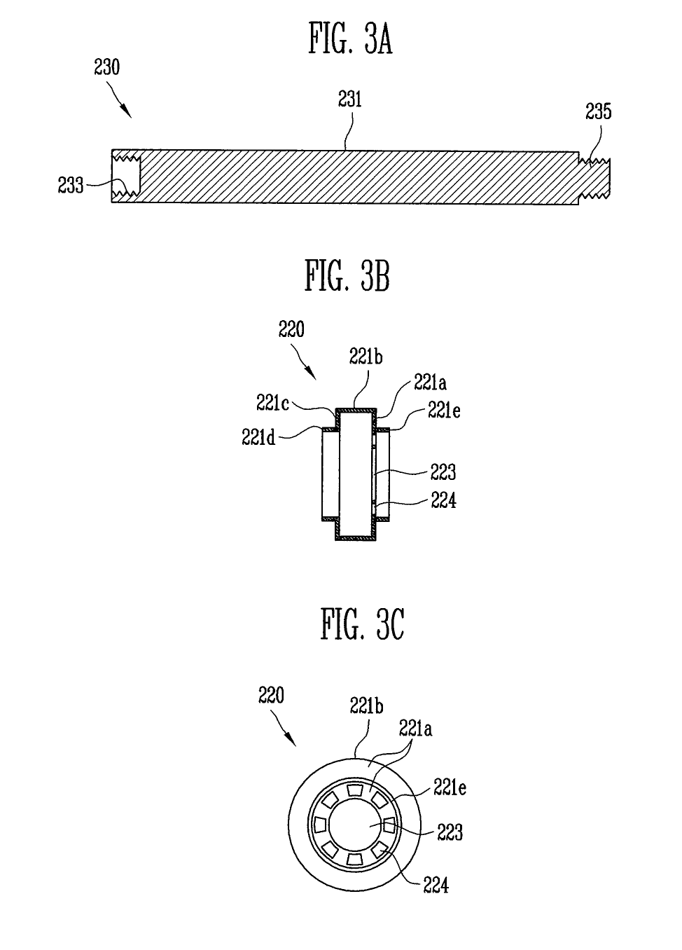

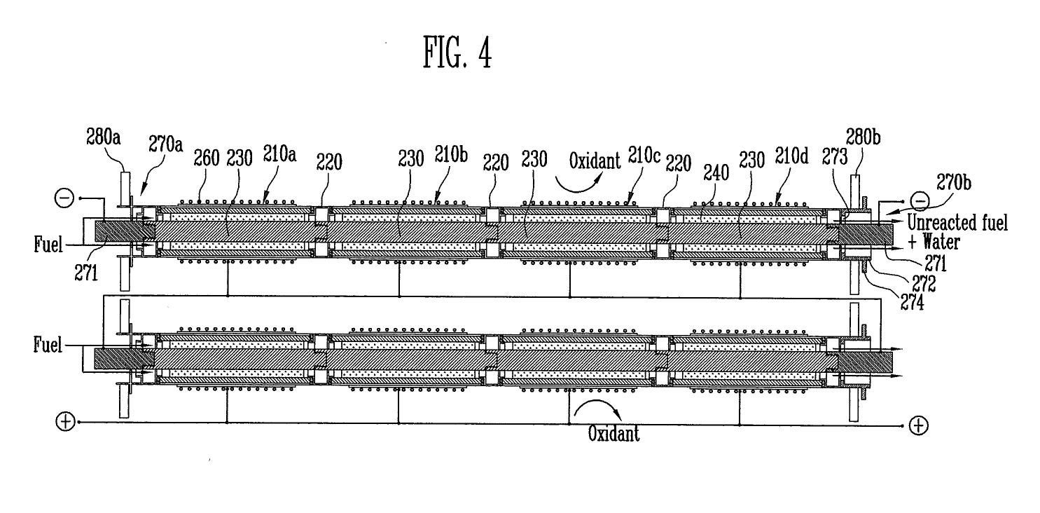

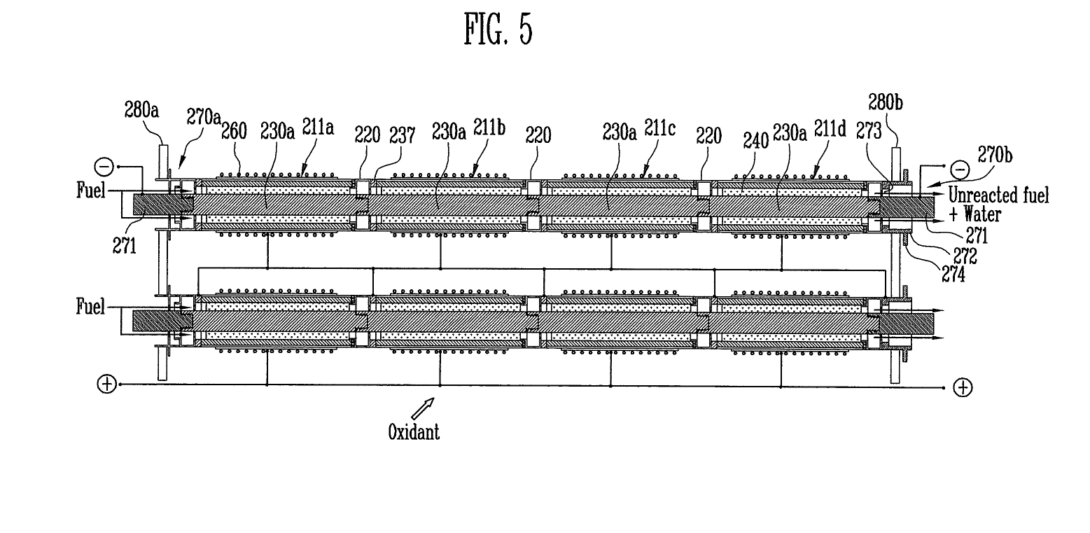

FIG. 2 is a partial cross-sectional view of a combined cell structure according to another embodiment. FIG. 3A is a cross-sectional view of the support member (including sub-support members) in the combined cell structure of FIG. 2. FIG. 3B is a cross-sectional view of a connector in the combined cell structure of FIG. 2. FIG. 3C is a front view of the connector depicted in FIGS. 2 and 3B. Referring to FIG. 2, the combined cell structure 200 includes a plurality of sub-cells 210a, 210b and 210c connected to each other along the fuel flow direction. Connectors 220 are disposed between adjacent sub-cells. A sealing member 250 may be provided between each of the sub-cells and the connector 220.

Each of the sub-cells 210a, 210b and 210c includes a first electrode 11 for forming a tube-type or flat-tube-type anode support body, a solid electrolyte 13 formed on the outer circumferential surface of the first electrode 11, a second electrode 15 formed on the solid electrolyte 13, and at least two connected sub-support members 230 passing through a hollow portion of the first electrode 11. A porous member 240 may be provided between the support member 230 and the first electrode 11.

As illustrated in FIG. 3A, the sub-support member 230 has a rod-shaped body 231 with a length. The body 231 may be a solid rod having no interior void space and may have a generally circular cross-section or a generally polygonal (i.e., a polygon inscribed or circumscribed in a circle) cross-section. One end of the body 231 may have a female threaded coupling 233, and the other end of the body 231 may have a male threaded coupling 235. The sub-support members 230 are connected by connecting a female threaded coupling 233 of one sub-support member with a male threaded coupling 235 of another sub-support member. The support member 230 may be made of stainless steel, nickel, a nickel alloy, or the like.

The connector 220 may be disposed to avoid direct contact between adjacent SOFC cells in the combined cell structure 200. The connector 220 may be formed of a conductive metal material. In one embodiment, as illustrated in FIGS. 3B and 3C, the connector 220 includes a disk-shaped first portion 221a and a second portion 221b extending from an edge of the first portion 221a along the thickness direction.

The area of the first portion 221a is similar to the cross-sectional area of the sub-cell. A first hole 223 is provided at the center of the first portion 221a. The sub-support member 230 can be inserted longitudinally through the first hole 223. A plurality of second holes 224 are provided around the first hole 223 and pass through the first portion 221a in the thickness direction. The plurality of second holes 224 allow a fluid to flow through the first portion 221a.

A projection 221e protrudes from the first portion in a direction opposite the direction in which the second portion 221b extends. The projection 221e is inserted in the hollow portion of the first of two adjacent sub-cell. The projection 221e may be a circular ring surrounding the plurality of second holes 224 at a side of the first portion 221a. The circular ring may be a solid line or dotted line.

The thickness of at least a portion of the second portion 221b is less than the thickness of the sub-support member 230. The second portion has an end 221d bent for insertion into the hollow portion of the second of the two adjacent sub-cells. The bent portion may include a stepped portion 221c. The stepped portion 221c may face one side (along the longitudinal direction) of the second sub-cell. If the thickness of at least a portion of the second portion 221b is thinner than the sub-support member 230, the connector 220 resiliently reacts when compressive stress is applied between the cells and the support members during operation of the combined cell structure 200, thereby reducing undesired thermal stress generated in the combined cell structure 200.

The porous member 240 may have a porous structure in which a fluid may flow along the outer circumferential surface of the support member 230. The porous member 240 is formed of a material with good conductivity so that the sub-support members 230 are electrically connected to the first electrode 11 in each of the sub-cells. The porous member 240 may be formed of a nickel felt, a metal felt (made of a metal other than nickel), a metal mesh, or the like.

The sealing member 250 seals the sub-cell and the connector. The sealing member 250 may include PYREX®, ceramic/glass composites, Thermiculite® #866, and the like. In another embodiment, the boundary portion between the sub-cell and the connector may be directly connected using a brazing technique.

Hereinafter, the process of manufacturing a sub-cell in the combined cell structure according to embodiments of the present invention will be described. First, an yttria-stabilized zirconia (YSZ) powder mixed with 40 vol°/0 nickel (Ni) is kneaded by adding activated carbon, an organic binder and water to the YSZ powder, and the kneaded slurry is extrusion-molded. After drying the extrusion-molded slurry, an anode support tube is prepared by sintering the dried slurry at about 1300° C.

Subsequently, the YSZ powder is prepared as an electrolyte slurry, and the electrolyte slurry is dip-coated on the anode support tube using a slurry coating technique. The electrolyte slurry coated on the anode support tube is dried at room temperature and then sintered at about 1400° C.

Then, a (La,Sr)MnO₃ (LSM) powder is prepared as a cathode slurry, and the cathode slurry is dip-coated on the electrolyte layer of the anode support tube. The cathode slurry coated on the electrolyte layer of the anode support tube is dried and then sintered at about 1200° C. The manufactured SOFC cell has an outer diameter of about 20 mm, an inner diameter of about 16 mm and a length of about 300 mm.

An SOFC sub-cell is then manufactured by preparing a sub-support member 230 formed of stainless steel, surrounding the sub-support member 230 with a nickel felt and then inserting the sub-support member 230 into a hollow portion of the SOFC cell.

FIG. 4 is a cross-sectional view of an SOFC stack including the combined cell structure of FIG. 2. Referring to FIG. 4, the SOFC stack according to embodiments of the present invention is manufactured by preparing individual combined cell structures and stacking a plurality of the prepared combined cell structures. Here, an individual combined cell structure is formed by connecting the sub-support members 230 of a plurality of tube-type or flat-tube-type sub-cells 210a, 210b, 210c and 210d to each another. In each of the combined cell structures, a connector 220 may be inserted between the sub-cells, and a boundary between the SOFC cell and the connector 220 may be sealed by a sealing member.

To form the cathode current corrector, a silver (Ag) wire may be wound on the second electrode of each of the sub-cells. Alternatively, a porous cathode current collecting layer on which a La_{0.9}Sr_{0.1}CoO₃ powder is coated (using a plasma spray technique) may be formed on the second electrode of each of the sub-cells. A wire or mesh formed of stainless steel and a Ni-based heat-resistant alloy may be used as the material of the cathode current collector. In one embodiment, for example, a Ag wire 250 is used as the cathode current collector, and the sub-support member 230 is used as the anode current collector.

One end of the combined cell structure (for example, a structure having four connected sub-cells 210a, 210b, 210c and 210d) may be connected to a first manifold 280a by a first end connector 270a. The other end of the combined cell structure may be connected to a second manifold 280b by a second end connector 270b. In such an embodiment, the two end connectors 270a and 270b connect the combined cell structure to the two manifolds 280a and 280b so that a fluid can flow therethrough while allowing the connected sub-support members 230 passing through the sub-cells to be fixed to the two manifolds 280a and 280b.

In one embodiment, each of the end connectors 270a and 270b includes a rod-shaped body 271 connected to the sub-support member 230, and a shielding portion 272 in the form of a band surrounding the body that provides support between the body and the manifold. At least one opening 273 is provided in the shielding portion to allow fuel to flow through the shielding portion. The body may be inserted into an opening in the manifold. A projection 274 may be provided to at least one surface of the shielding portion. A corner of the connector 220 or the manifold 280a or 280b may contact the shielding portion between the body and the projection. In one embodiment, the end connector 270a or 270b and the manifold 280a or 280b may be electrically isolated from each other by a separate insulating member 275 or insulative coating layer.

The cell stack including a plurality of combined cell structures may be configured such that the cathode current collector wire 260 of at least one combined cell structure is connected to the sub-support members 230 of at least one other combined cell structure. In such an embodiment, the wire 260 of the first combined cell structure is electrically connected to (e.g., by physically contacting) at least one of the two manifolds 280a or 280b (e.g., via the end connector), thereby electrically connecting the wire 260 with the sub-support members 230 of the second combined cell structure.

Hereinafter, operation of the SOFC stack according to embodiments of the present invention will be described with reference to the drawings. As shown in FIGS. 2 and 4, fuel flows from the first manifold 280a through openings in the end connectors to enter the combined cell structures. Then, the fuel flows through the sub-cells to the second manifold 280b by passing through a porous member 240 extending between the sub-support members 230 and first electrodes 11 of each of the sub-cells. An oxidant circulates about the exterior of the combined cell structures. Oxygen in the air may be used as the oxidant. The fuel may include methane, propane, butane or the like.

In each of the combined cell structures, electricity is generated by the electrochemical reaction of hydrogen (fuel) and oxygen (oxidant). Here, the hydrogen is supplied to the first electrode via a passage between the first electrode and the sub-support member of each of the sub-cells. The oxygen is supplied to the second electrode on the outer surface of each of the sub-cells. That is, the fuel that flows into the combined cell structure is reformed at an atmospheric temperature of about 600 to 1000° C. and converted into a reformate containing oxygen. Through the aid of an anode catalyst, the hydrogen supplied to the first electrode is bonded to oxygen ions at a high temperature, thereby producing water and electrons. Meanwhile, through the aid of a cathode catalyst and at a high temperature, the oxygen supplied to the second electrode is bonded to electrons that have been moved from the first electrode through an external circuit or load (not shown) connected to the SOFC stack, and thus converted into oxygen ions. The oxygen ions are moved to the second electrode by passing through an electrolyte. The water produced by the reaction of the hydrogen and the oxygen ions is discharged along with unreacted fuel to the second manifold 280b along the fuel flow direction between the sub-support members 230 and the first electrode. The electrons produced by the reaction of the hydrogen and the oxygen ions at the first electrode supply electric power to the load while moving toward the second electrode. The electrochemical reactions respectively generated at the first and second electrodes (anode and cathode) of each of the sub-cells are represented by the following Reaction Formula 1.

$$Anode \text{:} {H}^{2} + {O}^{2 -} \to {H}_{2} O + 2 {e}^{-} \\ Cathode \text{:} \frac{1}{2} {O}_{2} + 2 {e}^{-} \to {O}^{2 -} \qquad Reaction Formula 1$$

FIG. 5 is a cross-sectional view of an SOFC stack including a combined cell structure according to still another embodiment of the present invention. FIG. 6 is a cross-sectional view of a sub-support member in the SOFC stack of FIG. 5. Referring to FIG. 5, the SOFC stack is manufactured by stacking or arranging a plurality of combined cell structures. Here, each of the combined cell structures is formed by connecting a plurality of sub-cells 211a, 211b, 211c and 211d by connecting their respective sub-support members 230a. The SOFC stack illustrated in FIG. 5 is substantially identical to the SOFC stack illustrated in FIG. 4, except that the stack of FIG. 5 has a different serial connection structure than the stack of FIG. 4. In particular, in FIG. 4, the cathode current collector wire of a first combined cell structure is connected in series to the end connector of a second combined cell structure. In contrast, in FIG. 5, the cathode current collector wire of a first combined cell structure is connected in series to the sub-support members 230a of a second combined cell structure.

As illustrated in FIG. 6, the sub-support member 230a has a rod-shaped body 231a with a length. The rod-shaped body 231a may be a solid rod with no interior space. One end of the rod-shaped body 231a has a female threaded coupling 233, and the other end of the rod-shaped body 231a has a male threaded coupling 235. To connect two sub-support members 230a, the male threaded coupling 235 of a first sub-support member is coupled to the female threaded coupling 233 of a second sub-support member. The sub-support member 230a has a ring 237 with a thickness extending radially from an end of the body 231a. In some embodiments, the ring 237 extends from the end of the body 231a having the female threaded coupling 233. The ring 237 includes a plurality of openings 238 for allowing fuel to flow through the ring 237.

Referring back to FIG. 5, in some embodiments of the SOFC stack, the plurality of combined cell structures are connected by the cathode current collector wire 260. In particular, the cathode collector wire 260 of a first combined cell structure is connected to the sub-support members 230a of at least one second combined cell structure. That is, the cathode current collector wire 260 of the first combined cell structure is electrically connected to (e.g., by physically contacting) the rings 237 of the sub-support members 230a of the second combined cell structure 230a.

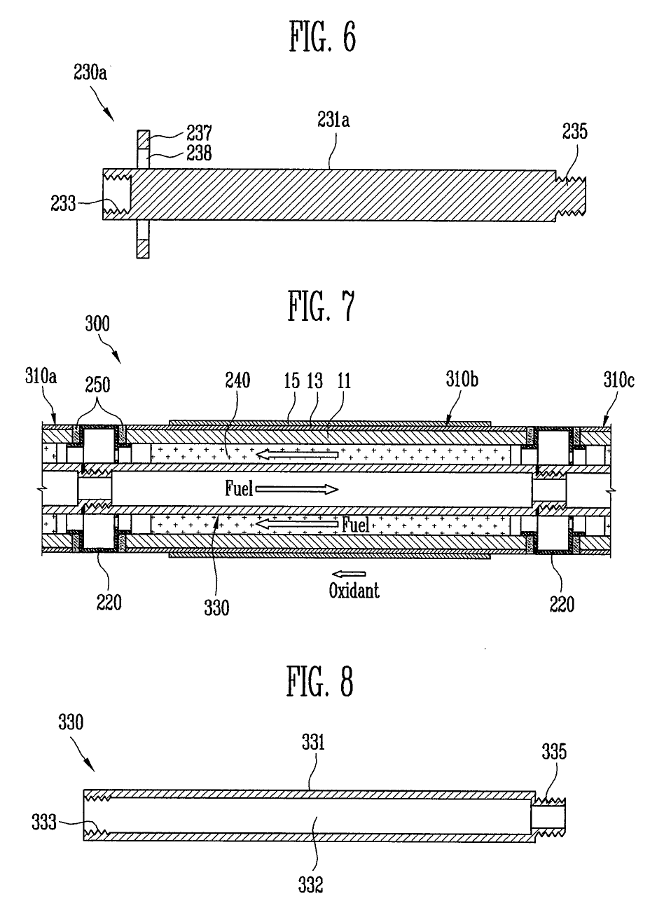

FIG. 7 is a partial cross-sectional view of combined cell structure 300 according to still another embodiment of the present invention. FIG. 8 is a cross-sectional view of a support member 330 that may be used in the combined cell structure of FIG. 7. Referring to FIG. 7, the combined cell structure 300 includes a plurality of sub-cells 310a, 310b and 310c connected to each other along a fuel flow direction. Connectors 220 may be disposed between adjacent sub-cells. The plurality of sub-cells are connected to each other along a longitudinal direction by connection of their respective sub-support members 330. Each of the sub-cells may have a porous member 240 disposed between the sub-support member 330 and the first electrode 11. A sealing member 250 may be provided between each of the sub-cells and the connector 220.

As illustrated in FIG. 8, according to some embodiments of the present invention, the support member 330 includes a generally tubular body 331 having a length. The body 331 has a hollow portion 332 and may have a generally circular cross-section or a generally polygonal (i.e., a polygon inscribed or circumscribed in a circle) cross-section. One end of the body 331 may have a female threaded coupling 333, and the other end of the body 331 may have a male threaded coupling 335. Adjacent sub-support members may be connected by coupling the female threaded coupling 331 of a first sub-support member with the male threaded coupling 335 of a second sub-support member. The female threaded coupling 333 is provided on an inner surface of the tubular body 331, and the male threaded coupling 335 is provided on an outer surface of the body 331. The sub-support member 330 may be formed of a solid material (such as stainless steel), having a strength.

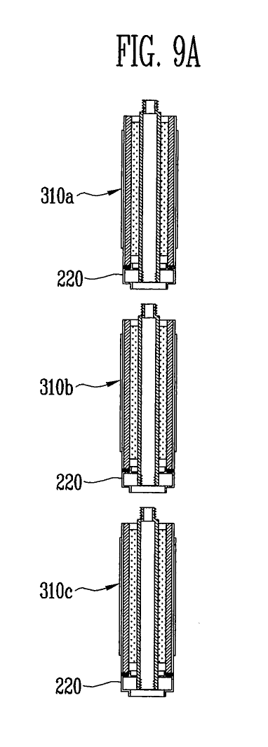

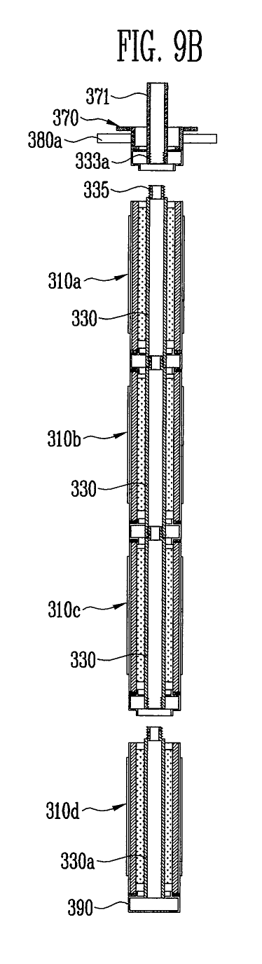

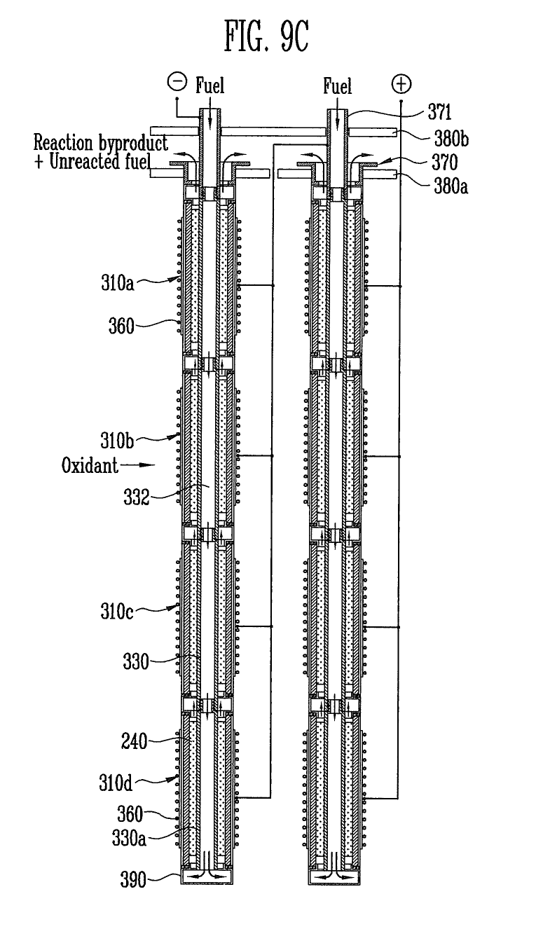

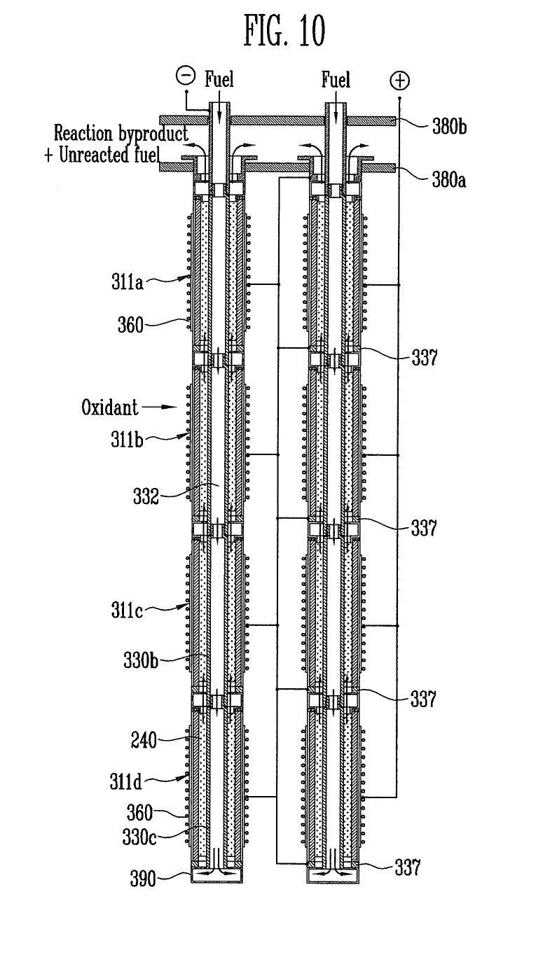

FIGS. 9A to 9C depict various steps in a process of manufacturing an SOFC stack using the combined cell structure of FIG. 7. First, as illustrated in FIG. 9A, the first, second and third sub-cells 310a, 310b and 310c are prepared, and the connector 220 is connected to one end of each of the sub-cells. A sealing member 250 is provided between each of the sub-cells and the connector 220. Each of the sub-cells and the connector 220 may be connected to each other using a brazing technique or the like.

Subsequently, as illustrated in FIG. 9B, the sub-support members 330 of adjacent sub-cells 310a, 310b and 310c are connected to each other by screwing the male threaded coupling 335 of one sub-support member 330 into the female threaded coupling 333 of an adjacent sub-support member 330. Then, a fourth sub-cell 310d is prepared, and the male threaded coupling 335 of the support member 330a of the fourth sub-cell 310d is coupled to the female threaded coupling 333 of the support member 330 of the third sub-cell 310c. The female threaded coupling may be omitted from the support member 330a of the fourth sub-cell 310d, and that end of the sub-cell 310d may be closed by a cap 390 having a thickness establishing a distance from the support member 330a.

The male threaded coupling 335 of the support member 330 in the first sub-cell 310a may be connected to the female threaded coupling 333a of an end connector 370 fixedly connected to a first manifold 380a. The end connector 370 may have a generally tubular body 371 for supplying fuel to the hollow portion 332 of the sub-support member 330.

Subsequently, as illustrated in FIG. 9C, an SOFC stack is manufactured by appropriately stacking or arranging a plurality of combined cell structures, each having first to fourth sub-cells 310a, 310b, 310c and 310d that are connected to each other along the fuel flow direction. The plurality of combined cell structures may be fixedly connected to the manifold by the end connector 370.

In some embodiments, the generally tubular body 371 of the end connector 370 may be positioned between the first manifold 380a and a second manifold 380b so that fuel can be supplied to each of the combined cell structures by flowing from the second manifold 380b to the first manifold 380a. The first and second manifolds 380a and 380b may form a two-level structure at one side of the combined cell structures.

Then, a cathode current collector 360 is formed by winding an Ag wire on the second electrode of each of the sub-cells 310a, 310b, 310c and 310d of each of the combined cell structures. The plurality of combined cell structures are electrically connected in series through the end connector 370 in the first manifold 380a.

Hereinafter, operation of the SOFC stack according to embodiments of the present invention will be described with reference to the drawings. Referring to FIG. 9C, fuel is supplied from the second manifold 380b to the hollow portion 332 of the sub-support members 330 of each of the combined cell structures via the tubular body 371 of the end connector 370. When the fuel reaches the end of the hollow portion of the sub-support member 330a of the fourth sub-cell 310d (positioned at one end of each combined cell structure), the fuel then flows in the opposite direction and passes through the porous members 240 between the sub-support members 330a and 330 and the first electrodes of the sub-cells.

Most of the fuel supplied to each of the combined cell structures is converted at a high temperature to a reformate containing hydrogen. The hydrogen is distributed and supplied (via the porous members 240) to the first electrodes of the respective sub-cells 310a, 310b, 310c and 310d.

The hydrogen supplied to the first electrodes electrically reacts with the oxygen supplied to the second electrodes (from the air), thereby producing electricity and water. The electricity is supplied to an external load (not shown) connected to the anode and cathode of the SOFC stack. The water is discharged along with any unreacted fuel to the first manifold 380a along the fuel flow direction.

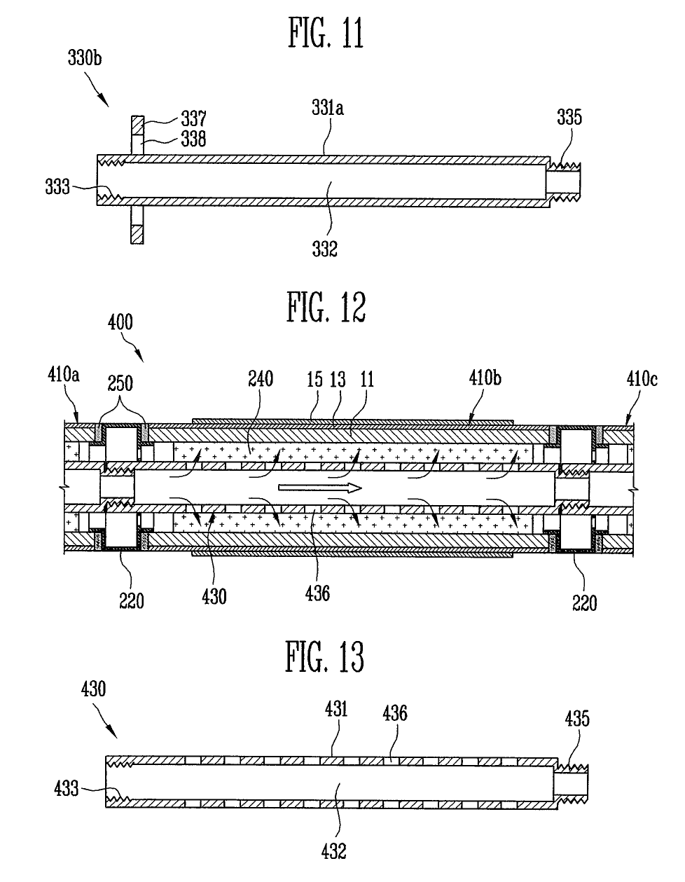

FIG. 10 is a cross-sectional view illustrating an SOFC stack including a combined cell structure according to still another embodiment of the present invention. FIG. 11 is a cross-sectional view of a sub-support member used in the combined cell structure depicted in FIG. 10. Referring to FIG. 10, according to embodiments of the present invention, the SOFC stack is manufactured by appropriately arranging a plurality of combined cell structures. Here, each of the combined cell structures is formed by connecting the respective sub-support members 330b of a plurality of sub-cells 311a, 311b, 311c and 311d. The SOFC stack depicted in FIG. 10 is substantially identical to the SOFC stack illustrated in FIG. 9, except that the stack of FIG. 9 has a different serial connection structure than the stack of FIG. 10. In particular, in FIG. 9, the cathode current collector wire of a first combined cell structure is connected in series to the end connector of a second combined cell structure. In contrast, in FIG. 10, the cathode current collector wire of a first combined cell structure is connected in series to the sub-support members 330b of a second combined cell structure.

As illustrated in FIG. 11, the sub-support member 330b includes a generally tubular body 331a having a hollow portion 332. One end of the body 331a has a female threaded coupling 333, and the other end of the body 331a has a male threaded coupling 335. To connect adjacent sub-support members 330b, the male threaded coupling 335 of one sub-support member is screwed into the female threaded coupling 333 of an adjacent sub-support member.

A ring 337 with a thickness extends radially from an end of the body 331a. In some embodiments, the ring 337 extends from the end of the body having the female threaded coupling 333. A plurality of openings 338 are provided in the ring 337 to allow fluid to flow through the ring 337. The ring 337 is substantially the same as the ring 237 described above with respect to FIG. 5, and the plurality of openings 338 may correspond in position to the second holes 224 in the connector 220 depicted in FIG. 3C.

The sub-support member 330c of the fourth sub-cell 311d is substantially identical to the sub-support member 330a of the fourth sub-cell 310d depicted in FIG. 9B, except that the sub-support member 330c depicted in FIG. 10 includes a ring 337 extending from an end (as in the sub-support member 330b).

Referring back to FIG. 10, according to embodiments of the present invention, in the SOFC stack, the cathode current collector 360 of at least one combined cell structure is electrically connected to the ring 337 of at least one sub-support member 330b of at least one other combined cell structure.

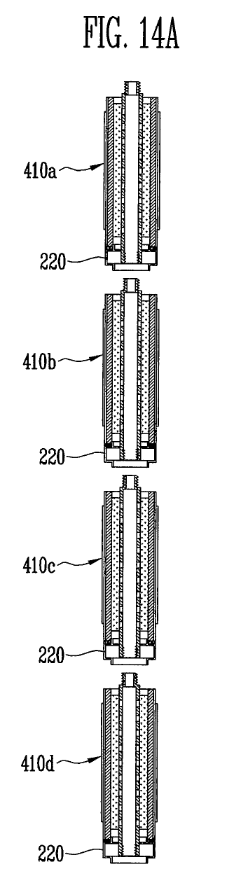

FIG. 12 is a partial cross-sectional view of a combined cell structure according to still another embodiment of the present invention. FIG. 13 is a cross-sectional view of a sub-support member that may be used in the combined cell structure of FIG. 12. Referring to FIG. 12, the combined cell structure 400 includes a plurality of sub-cells 410a, 410b and 410c connected to each other along the fuel flow direction. Connectors 220 may be disposed between adjacent sub-cells. The plurality of sub-cells are connected to each other by connection of their respective sub-support members 430. Each of the sub-cells may have a porous member 240 disposed between the support member 430 and the first electrode 11. A sealing member 250 may be provided between each of the sub-cells and the connector 220.

As illustrated in FIG. 13, according to embodiments of the present invention, the sub-support member 430 may have a generally tubular body 431 having a length. The body 431 has a hollow portion 432 and a plurality of openings 436 along the length of the body 432. The openings may be formed by cutting away portions of the body 431. One end of the body has a female threaded coupling 433, and the other end of the body has a male threaded coupling 435. Adjacent sub-support members may be connected to each other by screwing the male threaded coupling 435 of one sub-support member into the female threaded coupling 433 of an adjacent sub-support member. The sub-support member 430 may be formed of a solid material such as stainless steel.

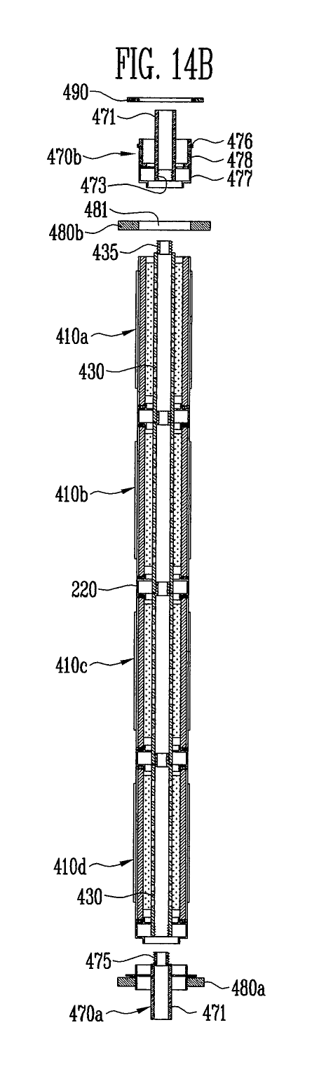

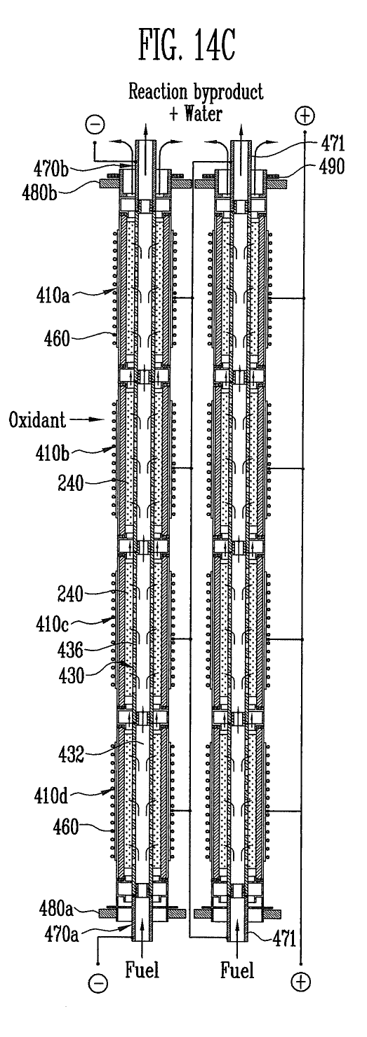

FIGS. 14A to 14C depict various steps in a process of manufacturing an SOFC stack having the combined cell structure of FIG. 12. First, as illustrated in FIG. 14A, the first, second, third and fourth sub-cells 410a, 410b, 410c and 410d are prepared, and connectors 220 are connected to one end of each of the sub-cells. Each of the sub-cells and the connectors 220 may be properly connected using a sealing member or a brazing technique.

Subsequently, as illustrated in FIG. 14B, the sub-support members 330 of the adjacent sub-cells 410a, 410b, 410c and 410d are connected to each other. Then, a male threaded coupling 475 of a first end connector 470a (including a fixedly connected first manifold 480a) is connected to the female threaded coupling 433 of the sub-support member 430 of the fourth sub-cell 410d. The first end connector 470a may have a generally tubular body for supplying fuel to the hollow portion 432 of the sub-support members 430 of each of the sub-cells.

Then, a female threaded coupling 473 of a second end connector 470b (inserted into an opening 481 of a second manifold 480b) is connected to the male threaded coupling 335 of the sub-support member 430 of the first sub-cell 410a. The second end connector 470b includes a generally tubular inner body 471 for discharging fluid exiting the combined cell structure, an outer body 478 generally surrounding the inner body 471 (generally forming a double pipe), a connector 477 for connecting between the inner body 471 and the outer body, and a plurality of openings (not shown) in the connector for allowing fluid to pass through the connector. The structure of the connector 477 of the second end connector 470b is substantially similar to that of the connector 220 described above with respect to FIG. 3B.

After the sub-support member 430 of the first sub-cell 410a is connected to the second end connector 470b, the second end connector 470b is fixed to the second manifold 480b by a fixing member 490. The fixing member 490 may be a ring having a threaded inner circumference. The second end connector 470b may have a male threaded coupling 476 on its outer surface, and the threaded inner circumference of the fixing member 490 may be connected to the male threaded coupling 476 of the second end connector 470b.

Subsequently, as illustrated in FIG. 14C, an SOFC stack is manufactured by appropriately stacking or arranging a plurality of combined cell structures, each combined cell structure having first to fourth sub-cells 410a, 410b, 410c and 410d connected to each other along the fuel flow direction. The plurality of combined cell structures may be connected to the first and second manifolds 480a and 480b via the first and second end connectors 470a and 470b, respectively.

In some embodiments, the first and second end connectors 470a and 470b connect the first and second manifolds 480a and 480b to each of the combined cell structures such that fuel is supplied from the first manifold 480a to the combined cell structures, and the reaction product (such as water and unreacted fuel) are discharged to the second manifold 480b.

A cathode current collector 460 is provided on the second electrode of each of the sub-cells 410a, 410b, 410c and 410d of each of the combined cell structures. In some embodiments, the cathode current collector 460 (which can be an Ag wire) of a first combined cell structure is connected to at least one end connector 470a or 470b of at least one second combined cell structure. That is, the cathode current collector 460 of the first combined cell structure is electrically connected to the end connectors 470a and 470b of the second combined cell structure, thereby forming a serially connected SOFC stack.

Hereinafter, operation of the SOFC stack according to embodiments of the present invention will be described with reference to the drawings. Referring to FIG. 14C, fuel is supplied (via the tubular body 471 of the first end connector 470a) from the first manifold 480a to the hollow portions 432 of the sub-support members 430 of each of the combined cell structures. Most of the fuel flows from the hollow portions 432 to the outer surfaces of the sub-support members 430 through the openings 436 and then flows through the porous members 240. The rest of the supplied fuel is flows to the second manifold 480b through the hollow portion 432 of the sub-support members 430.

The fuel in the combined cell structures is converted to a reformate containing hydrogen, and the hydrogen is supplied to the first electrode of each of the sub-cells 410a, 410b, 410c and 410d. The hydrogen supplied to the first electrode electrically reacts with oxygen supplied to the second electrode from the air, thereby producing electricity and water. The electricity is supplied to an external load (not shown) connected to the anode and cathode of the SOFC stack. The water is discharged along with any unreacted fuel to the second manifold 480b along the fuel flow direction.

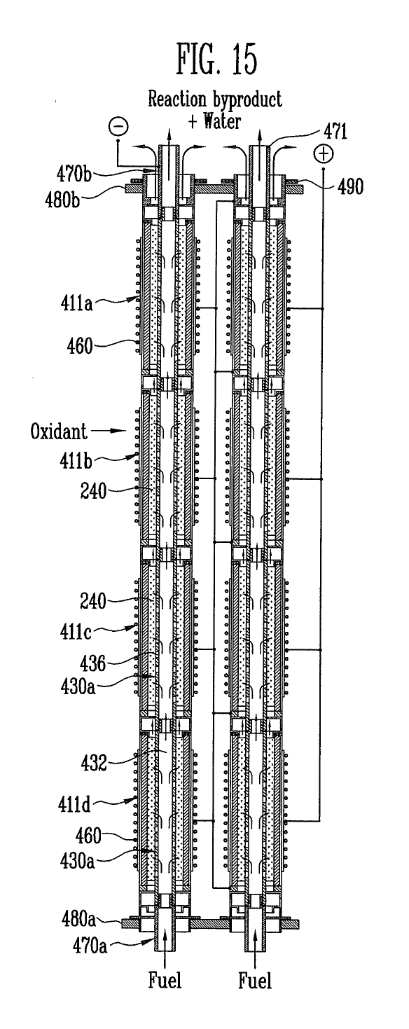

FIG. 15 is across-sectional view of an SOFC stack including a combined cell structure according to still another embodiment of the present invention. FIG. 16 is a cross-sectional view of a sub-support member used in the combined cell structure depicted in FIG. 15. Referring to FIG. 15, the SOFC stack is manufactured by stacking or arranging a plurality of combined cell structures. Here, each of the combined cell structures is formed by connecting the respective sub-support members 430a of a plurality of sub-cells 411a, 411b, 411c and 411d. The SOFC stack of FIG. 15 is substantially identical to the SOFC stack illustrated in FIG. 14C, except that the stack of FIG. 14C has a different serial connection structure than the stack of FIG. 15. In particular, in FIG. 14C, the cathode current collector wire of a first combined cell structure is connected in series to the end connector of a second combined cell structure. In contrast, in FIG. 15, the cathode current collector wire of a first combined cell structure is connected in series to the sub-support members 430a of a second combined cell structure.

As illustrated in FIG. 16, the sub-support member 430a includes a generally tubular body 431a having a length. The sub-support member 430a may be formed of a solid conducting material having a strength. The sub-support member 430a may be made of stainless steel, nickel, a nickel alloy, or the like. The body 431a has a hollow portion 432 and a plurality of openings 436 along the length of the body. The plurality of openings 436 may be formed by cutting away portions of the body 431a. One end of the body 431a has a female threaded coupling 433, and the other end of the body 431a has a male threaded coupling 435. To connect adjacent sub-support members, the male threaded coupling 435 of a first sub-support member is screwed into the female threaded coupling 433 of an adjacent sub-support member.

The plurality of openings 436 may be arranged at regular or irregular intervals along the length of the body 431a. The plurality of openings 436 may have any suitable shape and/or size, and any suitable number of openings may be provided so long as the strength of the sub-support member is not deteriorated to the point that it is no longer useful.

The sub-support member 430a may have a ring 437 with a thickness extending radially from an end of the body 431a. In some embodiments, the ring 437 extends from the end of the body 431a having the female threaded coupling. A plurality of openings 438 are provided in the ring 437 to allow fluid to flow through the ring 437.

Referring back to FIG. 15, in the SOFC stack, the cathode current collector 460 of a first combined cell structure may be connected to the ring 437 of at least one sub-support member 430a of at least one second combined cell structure. That is, an electrical connection node between the first and second combined cell structures may be formed at the ring 437 of the sub-support member 430a of the second combined cell structure.

FIGS. 17A and 17B are cross-sectional views of alternative mechanisms for connecting adjacent sub-support members. In the combined cell structures according to embodiments of the present invention, the connection of adjacent sub-support members has been described above as including screwing a male threaded coupling of a first sub-support member into a female threaded coupling of a second sub-support member. However, as illustrated in FIG. 17A, both ends of each of the sub-support members may have female threaded couplings, and adjacent sub-support members may be connected using a male adapter 50a. The male adapter has two male threaded couplings 53a and 53b at opposite sides of a body 51a having the same cross-sectional shape as that of the sub-support member. Here, a female threaded coupling 33a of a first sub-support member 30a is screwed onto the first male threaded coupling 53a of the male adapter 50a, and a female threaded coupling 33b of a second sub-support member 30b is screwed onto the second male threaded coupling 53b of the male adapter 50a. This results in the two sub-support members 30a and 30b being connected to each other along a longitudinal direction. As shown, the two sub-support members 30a and 30b face each other with the male adapter interposed therebetween.

Alternatively, as shown in FIG. 17B, both ends of each of the sub-support members may have male threaded couplings, and adjacent sub-support members may be connected using a female adapter 50b. The female adapter 50b includes a generally tubular body 51b with a threaded interior surface 55. Here, a male threaded coupling 35a of a first sub-support member 30c is screwed into a first side of the threaded surface 55 of the female adapter 51b, and a male threaded coupling 35b of a second sub-support member 30d is screwed into a second side of the threaded surface 55 of the female adapter 51b. This results in the two sub-support members 30c and 30d being connected to each other along a longitudinal direction. As shown, the two sub-support members 30c and 30d face each other with the female adapter in terposed therebetween.

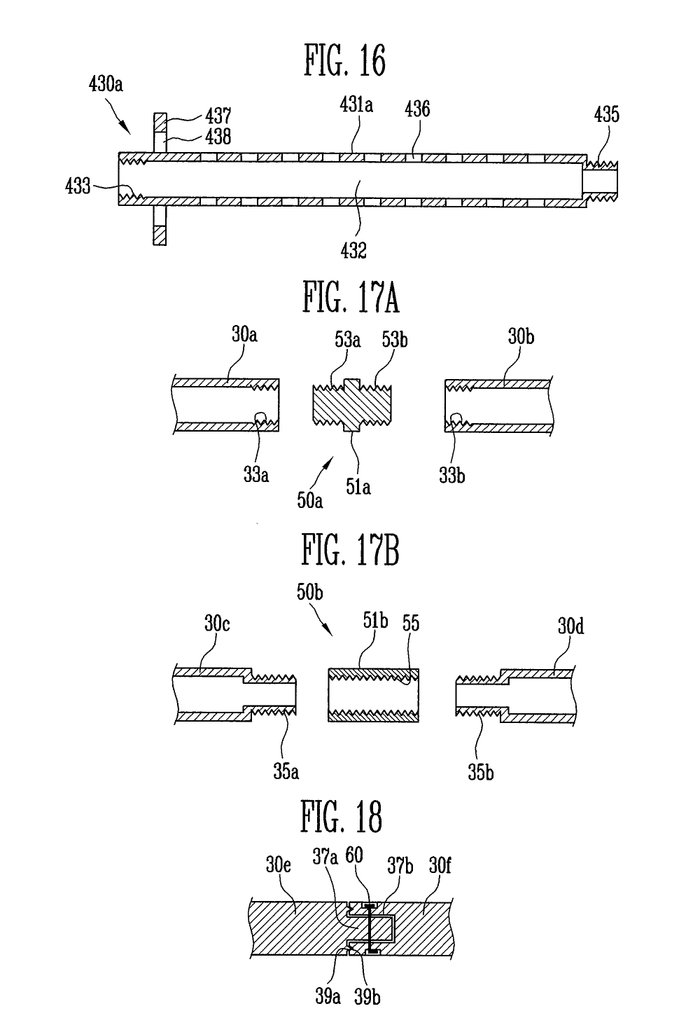

FIG. 18 is a cross-sectional view illustrating yet another mechanism for connecting adjacent sub-support members. As shown in FIG. 18, a rod-shaped sub-support member may include a first end having a protrusion 37a and a second end having a notch 37b. The protrusion 27a is shaped to fit within the notch 37b. Adjacent sub-support members may be connected by fitting the protrusion 37a of a first sub-support member 30e into the notch 37b of a second sub-support member 30f. The protrusion 37a may have a generally circular cross-section or a generally polygonal (i.e., a polygon inscribed or circumscribed in a circle) cross-section. The notch 37b may have a generally concave shape into which into which the protrusion 37a can be tightly inserted.

In some embodiments, the first sub-support member 30e may have at least one second protrusion 39a, and the second sub-support member 30f may have at least one second notch 39b, where the second protrusion 39a fits in the second notch 39b to prevent the protrusion 37a from rotating within the notch 37b.

In some embodiments, at least one fixing member 60 passes through the protrusion 37a and notch 37b to prevent the first and second sub-support members 30e and 30f from separating from each other. The fixing member 60 may be a pin and may have a head formed at one end of the fixing member 60. Here, the head may be larger than body of the fixing member 60. The end of the fixing member 60 passing through the first and second sub-support members 30e and 30f may be bent along the longitudinal direction of the sub-support member and adhered to a surface of the sub-support member.

Embodiments of the present invention provide several important benefits. First, tube-type anode support members used in anode supported SOFC cells are generally formed of a material such as porous Ni—YSZ cermet, and the anode supported SOFC cells are generally manufactured as cells having a length of 30 cm or shorter due to limitations in the mechanical strength of the material, high internal resistance, reduction of yield caused by large area, and the like. However, in embodiments of the present invention, a plurality of tube-type anode supported SOFC cells are connected along a longitudinal direction using sub-support members of the SOFC cells. This enables the production of SOFC combined cell structures having a length of about 120 cm or longer.

Second, when a plurality of anode supported SOFC cells are simply combined in a longitudinal direction (i.e., as compared to embodiments of the present invention), the connection of the anode supported SOFC cells is easily broken by temperature distributions (or temperature differences) between the connected cells or by mechanical stress generated at the connection to the manifold. However, in embodiments of the present invention, the plurality of anode supported SOFC cells are connected along the fuel flow direction using the sub-support members of the SOFC cells. This enables the production of SOFC combined cell structures that are not broken by thermal or mechanical stress. Further, embodiments of the present invention enable the easy design and manufacture of larger-sized SOFC systems.

Third, when large-sized SOFC systems are simply manufactured using a plurality of anode supported SOFC cells (i.e., as compared to embodiments of the present invention), designing a manifold to distribute and supply fuel to each of the SOFC cells is very difficult due to the large number of SOFC cells. However, according to embodiments of the present invention, the SOFC combined cell structures have a plurality of SOFC cells connected along a longitudinal direction, enabling simplification of the manifold design by considerably decreasing the number of SOFC cells. Accordingly, the uniform supply of fuel to each of the SOFC cells can be easily achieved.

Fourth, when a plurality of anode supported SOFC cells are simply connected in a longitudinal direction to increase length (i.e., as compared to embodiments of the present invention), electrical resistance between the SOFC cells increases, and external current collection is very difficult. However, according to embodiments of the present invention, a conductive support member (or a plurality of sub-support members) passes through a hollow portion of the tube-type or flat-tube-type SOFC cells. This enables the easy performance of external current collection without increasing electrical resistance between the SOFC cells.

While the present invention has been described in connection with certain exemplary embodiments, it is understood by those of ordinary skill in the art that certain modifications may be made to the described embodiments without departing from the spirit and scope of the present invention, as defined by the appended claims.

What is claimed is:

1. A cell stack for a solid oxide fuel cell, comprising:
at least two unit cells, each unit cell comprising a first electrode, a second electrode, and an electrolyte layer between the first and second electrodes, and having a hollow portion; and
a support member extending through the hollow portion in each unit cell and connecting the unit cells in series in a longitudinal direction.

2. The cell stack according to claim 1, further comprising a connector between adjacent unit cells, wherein the connector connects the adjacent unit cells together along the support member.

3. The cell stack according to claim 2, wherein the connector is configured to deform in response to stress from the unit cells.

4. The cell stack according to claim 2, further comprising a sealing member between each of the unit cells and the connector.

5. The cell stack according to claim 1, further comprising a current collector in contact with each of the second electrodes of the unit cells.

6. The cell stack according to claim 1, wherein the support member comprises a solid rod.

7. The cell stack according to claim 6, wherein the support member further comprises a ring protruding radially from an end thereof.

8. The cell stack according to claim 7, wherein the ring comprises at least one hole for allowing a fluid to flow through the ring.

9. The cell stack according to claim 6, wherein the ring is exposed to the outside.

10. The cell stack according to claim 6, further comprising a connector between adjacent unit cells, wherein the connector connects the adjacent unit cells together along the support member.

11. The cell stack according to claim 10, wherein the connector is configured to deform in response to stress from the adjacent unit cells.

12. The cell stack according to claim 1, wherein the support member comprises a hollow tube.

13. The cell stack according to claim 12, wherein the support member further comprises a ring protruding radially from an end thereof.

14. The cell stack according to claim 13, wherein the ring comprises at least one hole for allowing a fluid to flow through the ring.

15. The cell stack according to claim 12, further comprising a connector between adjacent unit cells, wherein the connector connects the adjacent unit cells together along the support member.

16. The cell stack according to claim 15, wherein the connector is configured to deform in response to stress from the adjacent unit cells.

17. The cell stack according to claim 12, wherein the support member comprises at least one opening in a sidewall of the tube.

18. The cell stack according to claim 17, wherein each support member further comprises a ring protruding radially from an end thereof.

19. The cell stack according to claim 18, wherein the ring comprises at least one hole for allowing a fluid to flow through the ring.

20. The cell stack according to claim 17, further comprising a connector between adjacent unit cells, wherein the connector connects the adjacent unit cells together along the support member.

21. The cell stack according to claim 20, wherein the connector is configured to deform in response to stress from the adjacent unit cells.

22. The cell stack according to claim 1, wherein the support member comprises a material selected from the group consisting of stainless steel, nickel and nickel alloys.

23. The cell stack according to claim 1, further comprising a porous member between the unit cells and the support member.

24. The cell stack according to claim 23, wherein the porous member comprises a material selected from the group consisting of metal felt, metal mesh and combinations thereof.

25. The cell stack according to claim 1, wherein the support member comprises at least two sub-support members extending through the unit cells, wherein the sub-support members are attached to each other.

26. The cell stack according to claim 25, wherein each of the sub-support members comprises a male threaded coupling at a first end and a female threaded coupling at a second end, and wherein the sub-support members are attached to each other by engagement of the male threaded coupling of one sub-support member with the female threaded coupling of another sub-support member.

27. The cell stack according to claim 25, wherein each of the sub-support members further comprises a ring protruding radially from an end thereof.

28. The cell stack according to claim 27, wherein the ring comprises at least one hole for allowing a fluid to flow through the ring.

29. The cell stack according to claim 25, wherein the sub-support member of a first end unit cell at a first end of the cell stack comprises a male threaded coupling at a first end, and the sub-support member of a second unit cell adjacent the first end unit cell comprises a male threaded coupling at a first end and a female threaded coupling at a second end, wherein the sub-support members of the first end unit cell and the second unit cell are attached to each other by engagement of the male threaded coupling of the sub-support member of the first end unit cell with the female threaded coupling of the sub-support member of the second unit cell.

30. The cell stack according to claim 29, further comprising an end cap on a second end of the sub-support member of the first end unit cell, and an end connector on the first end of the sub-support member of the second end unit cell.

31. The cell stack according to claim 30, further comprising a first end connector connecting the first end unit cell at a first end of the cell stack to a first manifold.

32. The cell stack according to claim 31, wherein the first end connector further connects the first end unit cell to a second manifold.

33. The cell stack according to claim 31, wherein the support member comprises a hollow tube, and the first end connector comprises a hollow tube in communication with the hollow tube of the support member.

34. The cell stack according to claim 1, further comprising a first end connector connecting a first end unit cell at a first end of the cell stack to a first manifold.

35. The cell stack according to claim 34, further comprising a second end connector connecting a second end unit cell at a second end of the cell stack to a third manifold.

36. The cell stack according to claim 35, wherein the support member comprises a hollow tube, and the second end connector comprises a hollow tube in communication with the hollow tube of the support member.

37. The cell stack according to claim 36, wherein the support member comprises a tube having at least one opening in a sidewall of the tube.

38. The cell stack according to claim 25, wherein each sub-support member comprises a male threaded coupling at each end, and wherein each of the sub-support members are attached to each other by engagement of the male threaded coupling of adjacent sub-support members with a female threaded adapter.

39. The cell stack according to claim 25, wherein each sub-support member comprises a female threaded coupling at each end, and wherein each of the sub-support members are attached to each other by engagement of the female threaded coupling of adjacent sub-support members with a male threaded adapter.

40. The cell stack according to claim 25, wherein each of the sub-support members comprises at least one notch at a first end, and at least one protrusion at a second end, the at least one protrusion being configured to fit within the at least one notch, and wherein each of the sub-support members are attached to each other by engagement of the at least one protrusion of one sub-support member with the notch of another sub-support member.

41. The cell stack according to claim 40, wherein each sub-support member further comprises a fixation member configured to fix the at least one protrusion in the at least one notch.

42. The cell stack according to claim 40, wherein the at least one protrusion and the at least one notch are configured to prevent substantial rotational movement of the at least one protrusion within the at least one notch.
